(19) United States
(12) Patent Application Publication
(10) Pub. No.: US 2024/0290198 A1
(43) Pub. Date: Aug. 29, 2024

(54) INTEGRATED AUTOMATIC PARKING SYSTEM AND AUTOMATIC PARKING METHOD USING THE SAME

(71) Applicant: HL MANDO CORPORATION, Gyeonggi-do (KR)

(72) Inventors: Jinmyung KIM, Seoul (KR); Kisung JO, Gyeonggi-do (KR)

(21) Appl. No.: 18/206,083

(22) Filed: Jun. 6, 2023

(30) Foreign Application Priority Data
Feb. 24, 2023 (KR) 10-2023-0024955

(51) Int. Cl. G08G 1/01; B60W 10/08; B60W 30/06; G07B 15/02; G08G 1/09

(52) U.S. Cl. CPC G08G 1/01; B60W 10/08; B60W 30/06; G07B 15/02; G08G 1/09; B60W 2554/80

(57) ABSTRACT

The present disclosure provides an integrated automatic parking system including: an integrated parking management unit that detects entry and exit of a vehicle in a parking lot, manages a state of occupancy of a parking space in the parking lot, acquires image information about the parking space, and transmits the acquired image information to a vehicle control unit mounted on an entered vehicle through a wireless communication method; and a parking route search unit that receives information on the entered vehicle entered into the parking lot and information on one or more non-occupied parking spaces of the parking lot from the integrated parking management unit, and searches a parking route for parking the entered vehicle in any one non-occupied parking space according to a set condition.

### CROSS-REFERENCE TO RELATED APPLICATIONS

This application claims priority under 35 U.S.C. § 119 to Korean Patent Application No. 10-2023-0024955, filed on Feb. 24, 2023, in the Korean Intellectual Property Office (KIPO), the disclosure of which is incorporated by reference herein in its entirety.

### TECHNICAL FIELD

The present disclosure relates to an integrated automatic parking system and an automatic parking method using the same, and specifically, to an integrated automatic parking system and an automatic parking method using the same, capable of quickly identifying a parking space, minimizing a space required for parking, and significantly reducing a parking time.

### BACKGROUND

Recently, due to the development of technology, many things operated by human power are being replaced with automated systems.

In addition, due to the development of the Internet, the introduction of a number of management systems using the Internet has become active, and the number of companies developing management systems using the Internet is also rapidly increasing.

The automobile industry has grown remarkably, but the growth has exceeded people's expectations, making it difficult to expand roads and parking spaces.

The manpower invested in the management of the parking space also causes a lot of labor costs, and it requires a high cost to manage a parking lot, but the operation of the parking facility is still insufficient.

As car culture has become commonplace, when using a car for business, it is required to park it in a parking lot, and if the parking lot is multi-story or divided into several zones, it is difficult to immediately check whether there is there is still room for parking despite the presence of a parking attendant.

In addition, conventionally, when there are many parked vehicles in a public parking lot or a parking lot of a building, a department store or the like, new vehicles entering the parking lot often wander in the parking lot to find a suitable parking space, which results in a problem that the driver wastes a lot of time.

FIG. 1 is a diagram showing a parking space required for parking in a case of general parallel parking, and FIG. 2 is a diagram showing a parking space required for parking in a case of general perpendicular parking.

Conventionally, in order to park in a parking position during automatic parking, it is necessary to repeatedly move forward and backward, so a space for steering is required in addition to a parking space.

In addition, since the position of the vehicle needs to be changed by moving forward and backward in order to perform precise parking, there is a problem in that the time required for parking is lengthened.

FIG. 3 is a diagram showing a general perpendicular parking process using arrows in order, and FIG. 4 is a diagram showing an example of an accident such as a pedestrian collision occurring in the general perpendicular parking process.

In the case of a conventional automatic parking system, it operates in the following order.

As shown in FIG. 3, \textcircled{1} an automatic parking vehicle searches for a parking space, then the automatic parking vehicle moves to the space required for parking and then starts parking, \textcircled{2} the automatic parking vehicle repeatedly moves to the space required for parking to perform alignment of a movement path, and \textcircled{3} after alignment of the movement path necessary for parking, parks in the parking position.

However, according to the conventional automatic parking system, the back and forth movement is repeated to align the movement path of the vehicle to the parking position, and this activity increases the parking time and, as shown in FIG. 4, there are problems that may cause an accident, such as a collision with a pedestrian.

In addition, the conventional automatic parking system has a problem in that additional space is required to perform the alignment of the movement path for parking.

### PRIOR ART DOCUMENT

### Patent Document

(Patent Document 1) KR 10-2022-0070774 A

### SUMMARY

In view of the above, the present disclosure provides an integrated automatic parking system and an automatic parking method using the same, capable of quickly identifying a parking space, minimizing a space required for parking, and significantly reducing parking time.

In accordance with one embodiment of the present disclosure, there is provided an integrated automatic parking system including: an integrated parking management unit that detects entry and exit of a vehicle in a parking lot, manages a state of occupancy of a parking space in the parking lot, acquires image information about the parking space, and transmits the acquired image information to a vehicle control unit mounted on an entered vehicle through a wireless communication method; and a parking route search unit that receives information on the entered vehicle entered into the parking lot and information on one or more non-occupied parking spaces of the parking lot from the integrated parking management unit, and searches a parking route for parking the entered vehicle in any one non-occupied parking space according to a set condition.

The integrated automatic parking system may further include a parking traffic control unit that controls traffic of an entered vehicle moving along the parking route searched by the parking route search unit and one or more entered vehicles moving in the parking lot.

The integrated automatic parking system may further include a parking guidance display unit that is displayed in a given manner along the parking route searched by the parking route search unit to guide the entered vehicle.

The parking guidance display unit is preferably an LED guidance light embedded in a bottom of the parking lot along a vehicle moving direction.

The integrated automatic parking system may further include a parking fee management unit that receives information on the entered vehicle from the integrated parking management unit, determine a parking fee until a time when the entered vehicle leaves the parking lot, and provide information on the determined parking fee to a user terminal of the entered vehicle.

A user of the entered vehicle may transmit information about the user to the parking fee management unit using the user terminal when entering the parking lot, and request for parking fee guidance of the parking lot.

The entered vehicle may include a parking space sensing unit, and the parking space sensing unit may receive image information about the parking space from the vehicle control unit to identify the parking space, and acquire sensing information about a lateral side of the vehicle.

The sensing information may include information on a space and distance on the lateral side of the entered vehicle and information on the presence or absence of obstacles.

The vehicle control unit may include a vehicle tilt detection unit for detecting a tilt angle of a parked vehicle with respect to a line perpendicular to a moving direction of the entered vehicle.

The vehicle control unit may further include a parking mode determination unit that determines whether to perform parallel parking or perpendicular parking based on the tilt angle of the vehicle detected by the vehicle tilt detection unit.

The vehicle control unit may transmit a signal to a vehicle drive unit of the entered vehicle so that the entered vehicle maintains a constant distance from a surrounding object and is located at an entrance of the parking space.

The vehicle drive unit may include an in-wheel motor mounted on each wheel of the vehicle, and each wheel is independently driven by the vehicle drive unit under the control of the vehicle control unit.

When the parallel parking is determined by the parking mode determination unit of the vehicle control unit, the vehicle control unit may perform the parallel parking by moving the entered vehicle to a rotation position in the parking space and then rotating the entered vehicle.

When the perpendicular parking is determined by the parking mode determination unit of the vehicle control unit, the vehicle control unit may perform the perpendicular parking by moving the entered vehicle parallel to the entrance of the parking space, rotating the entered vehicle by 90 degrees, and moving the entered vehicle into the parking space.

In accordance with another embodiment of the present disclosure, there is provided an integrated automatic parking system including an integrated parking management unit that detects entry and exit of a vehicle in a parking lot, manages a state of occupancy of a parking space in the parking lot, acquires image information about the parking space, and transmits the acquired image information to a vehicle control unit mounted on an entered vehicle through a wireless communication method, wherein the vehicle control unit receives information about the parking space from the integrated parking management unit and transmits a signal to a vehicle drive unit of the entered vehicle so that the entered vehicle maintains a constant distance from a surrounding object and is located at an entrance of the parking space, and the vehicle drive unit includes an in-wheel motor mounted on each wheel of the vehicle, and each wheel is independently driven by the vehicle drive unit under the control of the vehicle control unit.

The vehicle control unit may determine whether to perform parallel parking or perpendicular parking and transmits a signal to the vehicle drive unit, wherein when operating in the parallel parking, the vehicle control unit may move the entered vehicle to a rotation position in the parking space, and then rotate and park the entered vehicle, and when operating in the perpendicular parking, the vehicle control unit may move the entered vehicle parallel to the entrance of the parking space, rotates the entered vehicle by 90 degrees, and then moves the entered vehicle into the parking space to be parked.

The entered vehicle may include a parking space sensing unit, and the parking space sensing unit may receive image information about the parking space from the vehicle control unit to identify the parking space, and acquire sensing information about a lateral side of the vehicle.

The vehicle control unit may include a vehicle tilt detection unit for detecting a tilt angle of a parked vehicle with respect to a line perpendicular to a moving direction of the entered vehicle.

The vehicle control unit may further include a parking mode determination unit that determines whether to perform parallel parking or perpendicular parking based on the tilt angle of the vehicle detected by the vehicle tilt detection unit.

In accordance with still another embodiment of the present disclosure, there is provided an automatic parking method using the integrated automatic parking system described above.

Other specific details of the embodiments are included in the “Detailed Description” and the accompanying “drawings”.

Advantages and/or features of the present disclosure, and a method of achieving them, will become apparent upon reference to the various embodiments described below in detail in conjunction with the accompanying drawings.

However, the present disclosure is not limited to the configuration of each embodiment disclosed below, but may be implemented in various other forms, and each embodiment disclosed herein is provided to make the disclosure of the present disclosure complete, and to fully inform those skilled in the art to which the present disclosure pertains of the scope of the present disclosure. The present disclosure is only defined by the scope of the claims.

According to the embodiments of the present disclosure, the following effects are obtained.

By the parking integrated management unit and the parking route search unit, a parking space can be quickly identified, which saves time.

In addition, by the vehicle drive unit employing the in-wheel motor for each of the four wheels of the vehicle, each wheel of the vehicle drive unit can be independently driven by the vehicle drive unit under the control of the vehicle control unit. Accordingly, the vehicle can rotate in place, so that there is no need to repeat forward and backward movements, and the travel path is short, thereby minimizing the space required for parking and significantly reducing the time required for parking.

Further, by the parking traffic control unit for controlling the traffic of the vehicle moving along the parking route searched by the parking route search unit and one or more entered vehicles moving in the parking lot, congestion and accidents due to the movements of the vehicles in the parking lot can be prevented in advance.

Furthermore, by guiding the entered vehicle by displaying the parking route searched by the parking route search unit with the LED guide light embedded in the bottom of the parking lot along the direction in which the entered vehicle travels, the entered vehicle can safely and conveniently move to the searched parking space.

### BRIEF DESCRIPTION OF THE DRAWINGS

FIG. 1 is a view showing a parking space required for parking in case of general parallel parking.

FIG. 2 is a view showing a parking space required for parking in the case of general perpendicular parking.

FIG. 3 is a view showing a process of general perpendicular parking using arrows in order.

FIG. 4 is a view showing an example in which an accident such as a pedestrian collision occurs in a process of general perpendicular parking.

FIG. 5 is a view schematically showing the configuration of an integrated automatic parking system according to the present disclosure.

FIG. 6 is a view showing a vehicle drive unit employed in the integrated automatic parking system according to the present disclosure.

FIG. 7 shows a process of parking a vehicle into a parking space by the integrated automatic parking system according to the present disclosure.

FIG. 8 is a flowchart showing a process of parking a vehicle by the integrated automatic parking system according to the present disclosure in order.

FIG. 9 is a view illustrating a process of exchanging signals between a vehicle control unit and a vehicle drive unit after the completion of searching for a parking space in FIG. 8 and before parking is performed.

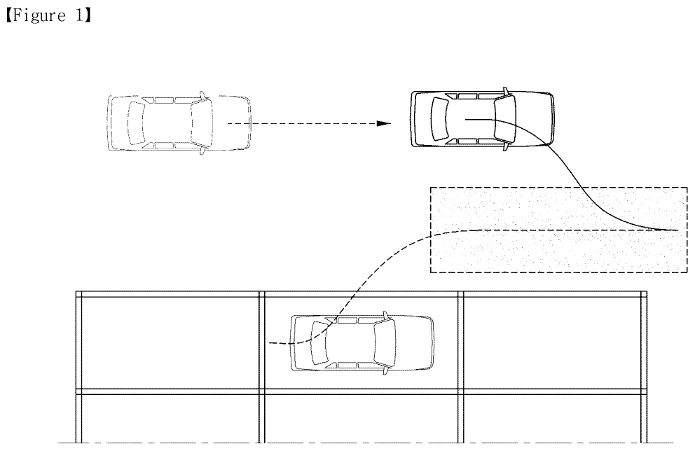

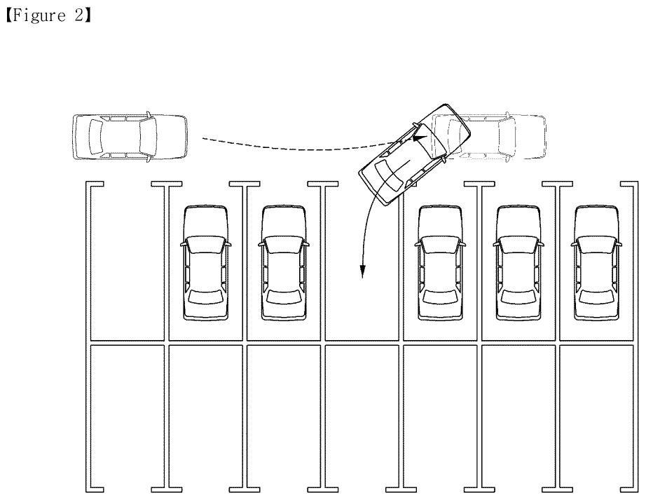

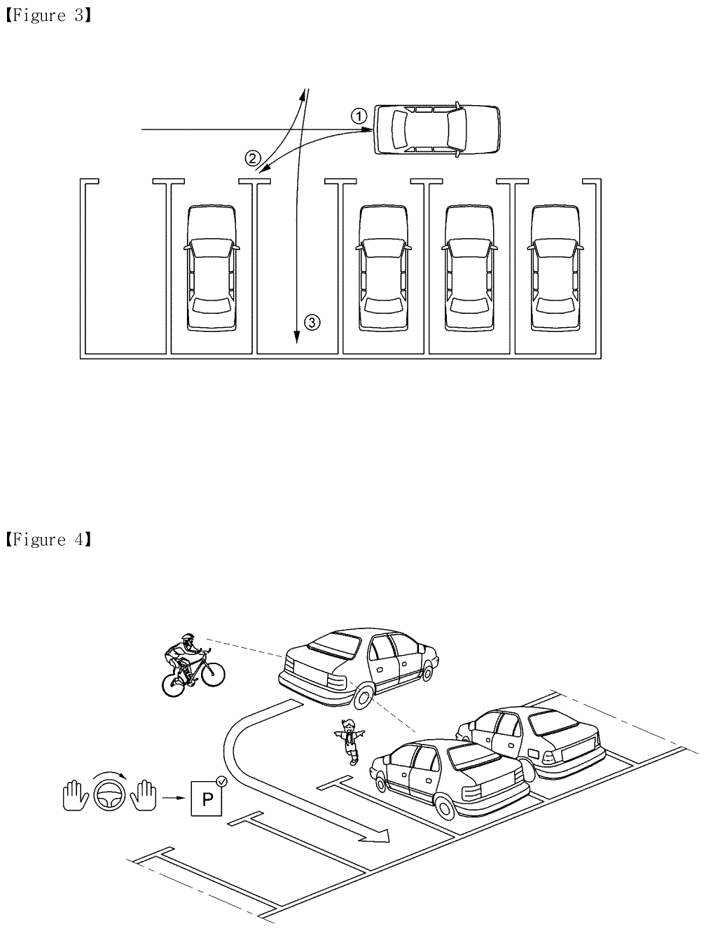

### DETAILED DESCRIPTION

Hereinafter, a preferred embodiment of an integrated automatic parking system and an automatic parking method using the same according to the present disclosure will be described in detail based on the accompanying drawings. For reference, the terms and words used in the present specification and claims should not be construed as being limited to their ordinary or dictionary meanings, and it should be interpreted as meaning and concept consistent with the technical idea of the present disclosure based on the principle that the inventors may appropriately define the concept of terms to describe their disclosure in the best way. In addition, the embodiments described in the present specification and the configurations shown in the drawings are only one of the most preferred embodiments of the present disclosure, and do not represent all of the technical ideas of the present disclosure, so it should be understood that there may be equivalents and variations in the time of the subject application.

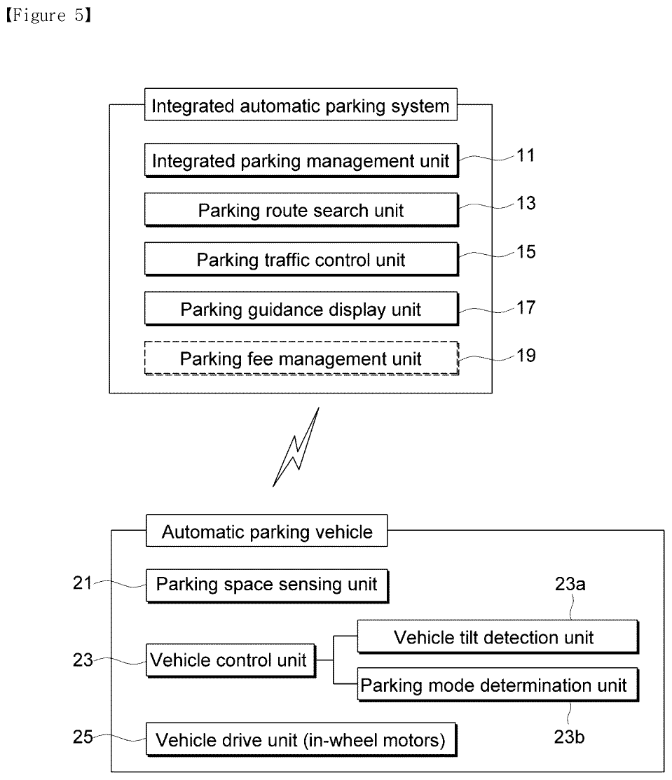

FIG. 5 is a view schematically showing the configuration of an integrated automatic parking system according to the present disclosure.

The integrated automatic parking system according to the present disclosure may include an integrated parking management unit 11, a parking route search unit 13, a parking traffic control unit 15, a parking guidance display unit 17, and a parking fee management unit 19.

The integrated parking management unit 11 detects entry and exit of vehicles in a parking lot, manages the state of occupancy of a parking space in the parking lot, acquires image information about the parking space, and transmits the acquired image information to a vehicle control unit 23 mounted on an entered vehicle through a wireless communication method.

The integrated parking management unit 11 may include a sensor unit for detecting entry and exit of a vehicle, and the sensor unit may be installed at an entrance of the parking lot and may include at least one of an image sensor, an optical sensor, an infrared sensor, a geomagnetic sensor, an ultrasonic sensor, and a pressure sensor.

In addition, the integrated parking management unit 11 may include a camera unit for acquiring image information about the parking space. The camera unit may include a plurality of camera units to be able to photograph the parking space, and as the camera unit, an IP (Internet Protocol) camera or CCTV (Closed Circuit Television) is preferably applied, but a CMOS camera or CCD camera may be applied, and a speed dome camera, a pinhole camera, a pan-tilt-zoom camera, etc. may be used, and furthermore, an infrared camera is additionally provided to enable photographing at night.

The information on entry and exit of the vehicle detected by the sensor unit and the image information on the parking space acquired by the camera unit are transmitted to a management server of the integrated parking management unit 11.

The parking route search unit 13 receives information about a vehicle entered into the parking lot and information about one or more non-occupied parking spaces of the parking lot from the integrated parking management unit 11, and searches a parking route for parking the entered vehicle in any one non-occupied parking space according to a set condition.

The parking traffic control unit 15 controls the traffic of the entered vehicle moving along the parking route searched by the parking route search unit 13 and one or more entered vehicles moving in the parking lot.

That is, based on the information on the entered vehicle stored in the management server of the integrated parking management unit 11, the parking traffic control unit 15 is configured to transmit movement paths to user terminals of the entered vehicles moving in the parking lot, so that congestion and accidents due to the movements of the vehicles in the parking lot can be prevented in advance.

The parking guidance display unit 17 is displayed in a given manner along the parking route searched by the parking route search unit 13 to guide the entered vehicle.

The parking guidance display unit 17 is preferably an LED guidance light embedded in the bottom of the parking lot along the moving direction of the vehicle, but may be replaced with any other configuration as long as it can guide the parking route.

The parking fee management unit 19 receives information about the entered vehicle from the integrated parking management unit 11, determines a parking fee until the time the entered vehicle leaves the parking lot, and provides information on the determined parking fee to the user terminal of the entered vehicle.

At this time, the user of the entered vehicle may transmit information about the user to the parking fee management unit 19 using the user terminal when entering the parking lot, and may request parking fee guidance of the parking lot.

Meanwhile, the entered vehicle includes a parking space sensing unit 21. The parking space sensing unit 21 receives image information about the parking space from the vehicle control unit 23, identifies the parking space, and acquires sensing information about a lateral side of the entered vehicle.

Such sensing information may include information on the space and distance on the lateral side of the entered vehicle and information about the presence or absence of obstacles.

In this case, the parking space sensing unit 21 may include a plurality of ultrasonic sensors, and the ultrasonic sensors may be mounted on left, right, front, and rear portions of the vehicle, respectively.

For example, the ultrasonic sensor mounted on the right portion of the vehicle measures a parallel distance to a vehicle on the right side.

In addition, in order to secure a minimum parking space, the sensor mounted on the front right portion of the vehicle may measure length and width of an empty parking space.

Further, the sensors mounted on the front and rear portions of the vehicle may be used to detect obstacles while moving forward or backward, or to adjust the distance between a vehicle on the front or rear side when parking the vehicle in a parking space.

In this case, the ultrasonic sensor constituting the parking space sensing unit 21 may generate a trigger pulse and measure a distance to an object by measuring the time required for the pulse to be reflected by the object and to enter into the ultrasonic sensor back.

In general, a microprocessor performs the process of generating and detecting the pulse, but in the case of an SRF-08 ultrasonic sensor module, a PIC chip is mounted on the module itself to generate pulses, and the module itself may perform a series of processes of measuring the distance.

In addition, the SRF-08 ultrasonic sensor module may transmit measured values to the microprocessor through I2C communication with the microprocessor.

The vehicle control unit 23 includes a vehicle tilt detection unit 23a for detecting a tilt angle of a parked vehicle with respect to a line perpendicular to the moving direction of the entered vehicle.

The vehicle control unit 23 further includes a parking mode determination unit 23b which determines whether to perform parallel parking or perpendicular parking based on the tilt angle of the vehicle detected by the vehicle tilt detection unit 23a (with respect to the line perpendicular to the moving direction of the entered vehicle).

Further, the vehicle control unit 23 transmits a signal to the vehicle drive unit 25 of the entered vehicle so that the entered vehicle maintains a constant distance from a surrounding object and is positioned at an entrance of the parking space.

In this way, when the parallel parking is determined by the parking mode determination unit 23b of the vehicle control unit 23, the vehicle control unit 23 transmits a signal to the vehicle drive unit 25 to move the entered vehicle to a rotation position in the parking space and then rotate the vehicle to perform the parallel parking.

In this case, the rotation position in the parking space means a position where the vehicle does not come into contact with front and rear vehicles when the vehicle rotates in the parking space.

It is recommended that the movement to the rotation position in the parking space be maintained at 45° towards the center of the parking space.

As an example, although the case where the vehicle goes straight and moves to the rotation position of the parking space is described as an example, the parallel parking is possible even when the vehicle moves backward to the rotation position of the parking space.

In addition, when the perpendicular parking is determined by the parking mode determination unit 23b of the vehicle control unit 23, the vehicle control unit 23 transmits a signal to the vehicle drive unit 25 to move the entered vehicle parallel to the entrance of the parking space, rotates the entered vehicle by 90 degrees and then move the entered vehicle into the parking space to perform the perpendicular parking.

In this case, the entrance of the parking space where the vehicle is located is a position where the vehicle does not come into contact with surrounding vehicles when rotating.

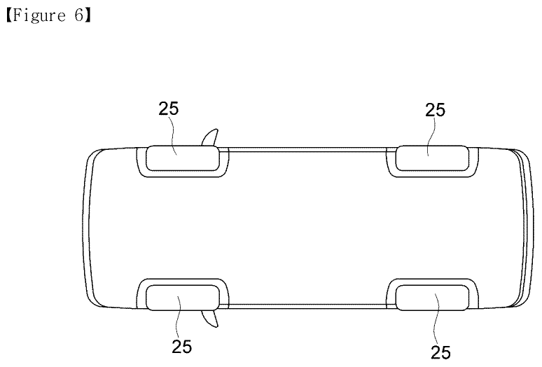

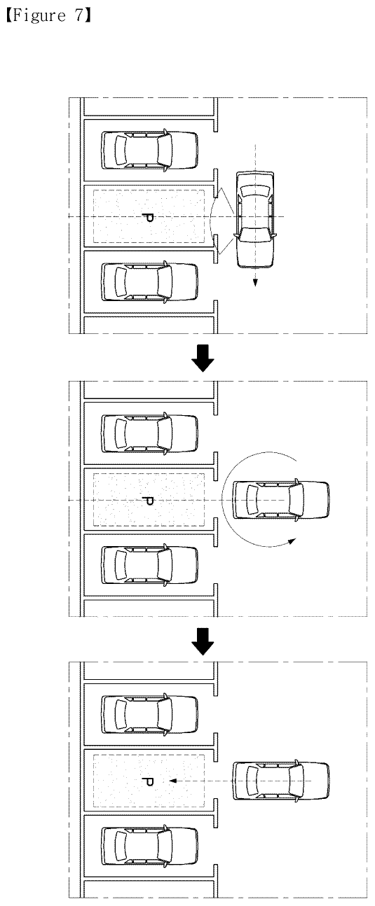

FIG. 6 is a view showing the vehicle drive unit employed in the integrated automatic parking system according to the present disclosure.

The vehicle drive unit 25 includes in-wheel motors mounted on the respective wheels of the vehicle, and each wheel is independently driven by the in-wheel motor of the vehicle drive unit 25 under the control of the vehicle control unit 23.

Since a vehicle equipped with the in-wheel motors can drive four wheels independently, the vehicle can be rotated clockwise or counterclockwise.

Accordingly, the vehicle equipped with the in-wheel motors can rotate in place.

In other words, when the in-wheel motor is applied to each of the four wheels of a vehicle and even steering of the four wheels is enabled, the vehicle can rotate in place and move sideways like a crab, which is a system that revolutionizes the perpendicular or parallel parking.

In addition, even without steering, when the rotation direction of the left wheels and the rotation direction of the right wheels are reversed, a so-called tank turn is also possible.

When the vehicle is not steered, the friction of the tires increases, so after adjusting the steering angle of the four wheels, rotating the left wheels and the right wheels in the opposite directions, the vehicle rotates smoothly in place.

FIG. 7 shows a process of parking a vehicle into the parking space by the integrated automatic parking system according to the present disclosure.

The vehicle control unit 23 may determine whether to perform the parallel parking or the perpendicular parking, and transmit a signal to the vehicle drive unit 25. In the case of the parallel parking operation, the vehicle control unit 23 may move the entered vehicle to a rotation position in the parking space to rotate and park the entered vehicle. In the case of perpendicular parking operation, as shown in FIG. 7, the vehicle control unit 23 may move the entered vehicle parallel to the entrance of the parking space, rotate it by 90 degrees, and then moves and park it to the parking space.

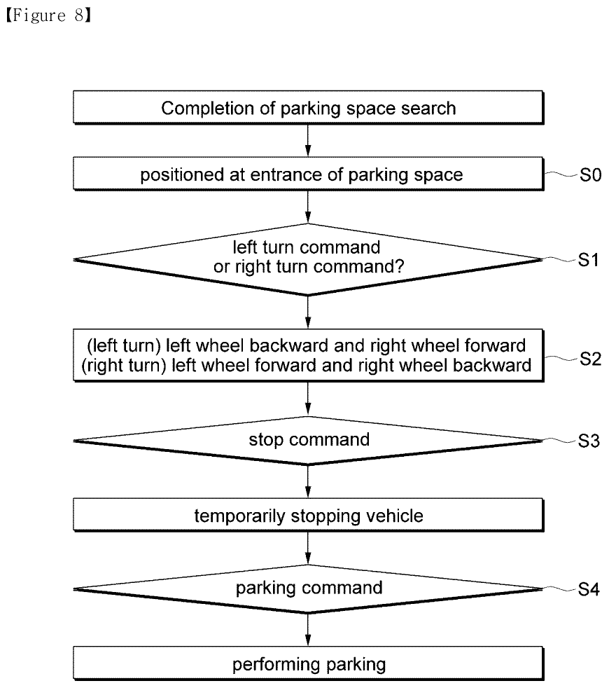

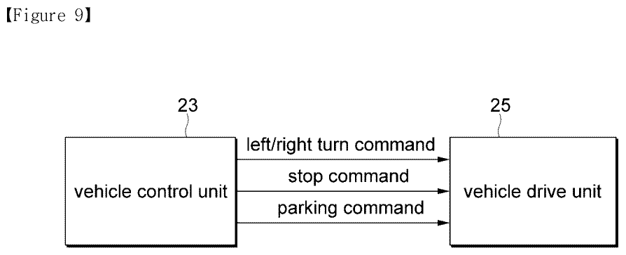

FIG. 8 is a flowchart showing a process of parking a vehicle by the integrated automatic parking system according to the present disclosure in order, and FIG. 9 is a view illustrating a process of exchanging signals between the vehicle control unit and the vehicle drive unit after the completion of searching for a parking space in FIG. 8 and before parking is performed.

When the parking space search is completed by the integrated parking management unit 11 and the parking route search unit 13, the vehicle control unit 23 transmits a signal to the vehicle drive unit 25 (in-wheel motors) of the entered vehicle so that the entered vehicle is properly positioned at the entrance of the parking space (S0).

Thereafter, the vehicle control unit 23 transmits a left turn command or a right turn command to the vehicle drive unit 25 (in-wheel motors) (S1), and the vehicle drive unit 25 (in-wheel motors) transmits a predetermined amount of driving torque in different directions (S2).

For example, the left turn command includes a left wheel backward command and a right wheel forward command, and the right turn command includes a left wheel forward command and a right wheel backward command.

As such, when the direction to the parking space and the reverse direction of the vehicle are aligned, the vehicle control unit 23 transmits a stop command (S3) to temporarily stop the vehicle.

Thereafter, the vehicle control unit 23 transmits a parking command to the vehicle drive unit 25 (in-wheel motors) (S4), and the vehicle drive unit 25 (in-wheel motors) performs parking of the vehicle.

The above-described process in which the vehicle is parked by the integrated automatic parking system can be written in a computer program.

In addition, codes and code segments constituting the program can be easily inferred by a computer programmer in the art.

In addition, the program written as described above is stored in a computer-readable recording medium (information storage medium), and is read and executed by a computer to implement the automatic parking method using the integrated automatic parking system of the present disclosure.

Moreover, the recording medium includes all types of computer-readable recording mediums.

The present disclosure described above is not limited by the above-described embodiments and the accompanying drawings, and it will be clear to those skilled in the art to which the present disclosure pertains that various substitutions, modifications, and changes are possible within the scope of the technical idea of the present disclosure.

### DESCRIPTION OF REFERENCE NUMERALS

11: Integrated parking management unit
13: Parking route search unit
15: Parking traffic control unit
17: Parking guidance display unit
19: Parking fee management unit
21: Parking space sensing unit
23: Vehicle control unit
23a: Vehicle tilt detection unit
23b: Parking mode determination unit
25: Vehicle drive unit

What is claimed is:

1. An integrated automatic parking system comprising:
an integrated parking management unit that detects entry and exit of a vehicle in a parking lot, manages a state of occupancy of a parking space in the parking lot, acquires image information about the parking space, and transmits the acquired image information to a vehicle control unit mounted on an entered vehicle through a wireless communication method; and
a parking route search unit that receives information on the entered vehicle entered into the parking lot and information on one or more non-occupied parking spaces of the parking lot from the integrated parking management unit, and searches a parking route for parking the entered vehicle in any one non-occupied parking space according to a set condition.

2. The integrated automatic parking system of claim 1, further comprising a parking traffic control unit that controls traffic of an entered vehicle moving along the parking route searched by the parking route search unit and one or more entered vehicles moving in the parking lot.

3. The integrated automatic parking system of claim 1, further comprising a parking guidance display unit that is displayed in a given manner along the parking route searched by the parking route search unit to guide the entered vehicle.

4. The integrated automatic parking system of claim 3, wherein the parking guidance display unit is an LED guidance light embedded in a bottom of the parking lot along a vehicle moving direction.

5. The integrated automatic parking system of claim 1, further comprising a parking fee management unit that receives information on the entered vehicle from the integrated parking management unit, determines a parking fee until a time when the entered vehicle leaves the parking lot, and provides information on the determined parking fee to a user terminal of the entered vehicle.

6. The integrated automatic parking system of claim 5, wherein a user of the entered vehicle transmits information about the user to the parking fee management unit using the user terminal when entering the parking lot, and requests for parking fee guidance of the parking lot.

7. The integrated automatic parking system of claim 1, wherein the entered vehicle includes a parking space sensing unit, and
wherein the parking space sensing unit receives image information about the parking space from the vehicle control unit to identify the parking space, and acquires sensing information about a lateral side of the vehicle.

8. The integrated automatic parking system of claim 7, wherein the sensing information includes information on a space and distance on the lateral side of the entered vehicle and information on the presence or absence of obstacles.

9. The integrated automatic parking system of claim 1, wherein the vehicle control unit includes a vehicle tilt detection unit for detecting a tilt angle of a parked vehicle with respect to a line perpendicular to a moving direction of the entered vehicle.

10. The integrated automatic parking system of claim 9, wherein the vehicle control unit further includes a parking mode determination unit that determines whether to perform parallel parking or perpendicular parking based on the tilt angle of the vehicle detected by the vehicle tilt detection unit.

11. The integrated automatic parking system of claim 10, wherein the vehicle control unit transmits a signal to a vehicle drive unit of the entered vehicle so that the entered vehicle maintains a constant distance from a surrounding object and is located at an entrance of the parking space.

12. The integrated automatic parking system of claim 11, wherein the vehicle drive unit includes an in-wheel motor mounted on each wheel of the vehicle, and each wheel is independently driven by the vehicle drive unit under the control of the vehicle control unit.

13. The integrated automatic parking system of claim 12, wherein when the parallel parking is determined by the parking mode determination unit of the vehicle control unit, the vehicle control unit performs the parallel parking by moving the entered vehicle to a rotation position in the parking space and then rotating the entered vehicle.

14. The integrated automatic parking system of claim 12, wherein when the perpendicular parking is determined by the parking mode determination unit of the vehicle control unit, the vehicle control unit performs the perpendicular parking by moving the entered vehicle parallel to the entrance of the parking space, rotating the entered vehicle by 90 degrees, and moving the entered vehicle into the parking space.

15. An integrated automatic parking system comprising:
an integrated parking management unit that detects entry and exit of a vehicle in a parking lot, manages a state of occupancy of a parking space in the parking lot, acquires image information about the parking space, and transmits the acquired image information to a vehicle control unit mounted on an entered vehicle through a wireless communication method,
wherein the vehicle control unit receives information about the parking space from the integrated parking management unit and transmits a signal to a vehicle drive unit of the entered vehicle so that the entered vehicle maintains a constant distance from a surrounding object and is located at an entrance of the parking space, and
wherein the vehicle drive unit includes an in-wheel motor mounted on each wheel of the vehicle, and each wheel is independently driven by the vehicle drive unit under the control of the vehicle control unit.

16. The integrated automatic parking system of claim 15, wherein the vehicle control unit determines whether to perform parallel parking or perpendicular parking and transmits a signal to the vehicle drive unit,
wherein when operating in the parallel parking, the vehicle control unit moves the entered vehicle to a rotation position in the parking space, and then rotates and parks the entered vehicle, and
wherein when operating in the perpendicular parking, the vehicle control unit moves the entered vehicle parallel to the entrance of the parking space, rotates the entered vehicle by 90 degrees, and then moves the entered vehicle into the parking space to be parked.

17. The integrated automatic parking system of claim 16, wherein the entered vehicle includes a parking space sensing unit, and
wherein the parking space sensing unit receives image information about the parking space from the vehicle control unit to identify the parking space, and acquires sensing information about a lateral side of the vehicle.

18. The integrated automatic parking system of claim 15, wherein the vehicle control unit includes a vehicle tilt detection unit for detecting a tilt angle of a parked vehicle with respect to a line perpendicular to a moving direction of the entered vehicle.

19. The integrated automatic parking system of claim 18, wherein the vehicle control unit further includes a parking mode determination unit that determines whether to perform parallel parking or perpendicular parking based on the tilt angle of the vehicle detected by the vehicle tilt detection unit.

20. An automatic parking method using the integrated automatic parking system of claim 15.
